(19) United States
(12) Patent Application Publication
(10) Pub. No.: US 2026/0112679 A1
(43) Pub. Date: Apr. 23, 2026

(54) STACKING DEVICE AND METHOD OF STACKING BATTERY CELLS

(71) Applicants: Hyundai Motor Company, Seoul (KR); Kia Corporation, Seoul (KR); JOIL MACHINERY CO., LTD, Ulsan (KR)

(72) Inventors: Sa Hwan Kim, Hwaseong (KR); Kyung Hwan Lim, Hwaseong (KR); Bo Ram Lyu, Hwaseong (KR); Young Chae Yu, Hwaseong (KR); Taek Yeol Kwon, Ulsan (KR)

(21) Appl. No.: 19/337,516

(22) Filed: Sep. 23, 2025

(30) Foreign Application Priority Data
Oct. 18, 2024 (KR) 10-2024-0143355
Jul. 22, 2025 (KR) 10-2025-0098954

(51) Int. Cl. H01M 10/04; B65G 57/28; B65G 57/32

(52) U.S. Cl. CPC H01M 10/0404; B65G 57/28; B65G 57/32

(57) ABSTRACT

A stacking device includes a rotary holder including a holder portion, the rotary holder being rotatable, and a stacking station including a support portion, the stacking station being operatively associated with the rotary holder.

### CROSS-REFERENCE TO RELATED APPLICATION

This application claims, under 35 U.S.C. § 119 (a), the benefit of Korean Patent Application No. 10-2024-0143355, filed Oct. 18, 2024, in the Korean Intellectual Property Office, and Korean Patent Application No. 10-2025-0098954, filed Jul. 22, 2025, in the Korean Intellectual Property Office, the entire contents of which are incorporated herein by reference.

### BACKGROUND

### (a) Technical Field

The present disclosure relates to a stacking device for items and, in particular, to systems and methods for stacking battery cells.

### (b) Background

A stacking device is a device capable of stacking a plurality of items having a same shape or different shapes. Stacking of items may be performed for storage of the items, transportation of the items, or integration of the stacked items. For example, such a stacking device may be used in a manufacturing process of a battery, such as a secondary battery.

A battery may comprise a plurality of battery cells electrically connected to each other. For example, a battery may comprise a large number of battery cells instead of a small number of battery cells to meet required output performance.

In a battery comprising a plurality of battery cells, the respective battery cells may be stacked on top of each other using a stacking device. In one example, a battery module may be manufactured by stacking a plurality of battery cells. In another example, a battery pack may be manufactured from a plurality of stacked battery cells.

The above information disclosed in this Background section is only for enhancement of understanding of the background of the disclosure, and therefore it may contain information that does not form the prior art that is already known to one having ordinary skill in the art.

### SUMMARY

The present disclosure has been made in an effort to solve the above-described problems associated with the prior art, and it is an aspect of the present disclosure to provide a stacking device and a stacking method, capable of effectively and efficiently stacking a large number of items.

It is another aspect of the present disclosure to provide a stacking device capable of accurately aligning battery cells to be stacked.

It is still another aspect of the present disclosure to provide a stacking device and a stacking method, capable of reducing manufacturing costs through a simplified structure.

The aspects of the present disclosure are not limited to the above-mentioned aspects, and other technical aspects not mentioned herein will be clearly understood by one having ordinary skilled in the art to which the present disclosure pertains from the detailed description of the embodiments.

In one aspect, a stacking device may include a rotary holder including a holder portion, the rotary holder being rotatable, and a stacking station including a support portion, the stacking station being operatively associated with the rotary holder.

In another aspect, a battery-manufacturing device may include a stacking device. The stacking device may include a conveyor, a rotary holder including a holder portion, the rotatory holder being rotatable and being movable relative to the conveyor, and a stacking station including a support portion, the stacking station being operatively associated with the rotary holder.

In still another aspect, a method of stacking battery cells may include supplying the battery cell by a conveyor, holding the battery cell by a rotary holder, rotating the rotary holder, and stacking, on a stacking station, the battery cell rotated by the rotary holder.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

According to an aspect of the present disclosure, a stacking device is provided. The stacking device may comprise a rotary holder comprising a holder portion and configured to rotate, and a stacking station comprising a support portion and configured to be operatively associated with the rotary holder.

According to an exemplary embodiment, the stacking device may comprise a conveyor. The rotary holder may be configured to move in one or more of a first direction, a second direction, or a third direction relative to the conveyor.

According to an exemplary embodiment, the rotary holder may be configured to rotate toward the support portion and move toward the support portion.

According to an exemplary embodiment, the support portion may be configured to move along, or together with, the stacking station.

According to an exemplary embodiment, the stacking device may comprise a position sensor and a controller configured to adjust, based on information from the position sensor, a position of the rotary holder.

According to an exemplary embodiment, the stacking device may comprise a pusher configured to move toward the rotary holder.

According to an exemplary embodiment, the rotary holder may comprise a plurality of holder portions disposed along a circumference of the rotary holder, and each of the holder portions may comprise a vacuum pad configured to receive a vacuum.

According to an aspect of the present disclosure, a battery-manufacturing device may be provided. The battery-manufacturing device may comprise a stacking device. The stacking device may comprise a conveyor and a rotary holder comprising a holder portion. The rotatory holder may be configured to rotate and move relative to the conveyor. The stacking device may comprise a stacking station comprising a support portion. The stacking station may be configured to be operatively associated with the rotary holder.

According to an aspect of the present disclosure, a method of stacking battery cells is provided. The method may comprise, using a stacking device, supplying a battery cell by the conveyor, holding the battery cell by the rotary holder, rotating the rotary holder, and stacking, on the stacking station, the battery cell rotated by the rotary holder.

According to an exemplary embodiment, the method may comprise determining, by a position sensor, a position of the battery cell held by the rotary holder, and adjusting a position of the rotary holder based on the position of the battery cell.

According to an exemplary embodiment, the determining a position of the battery cell may comprise moving the rotary holder toward the position sensor.

According to an exemplary embodiment, the method may comprise moving, by a pusher, the battery cell held by the rotary holder to a preset position.

According to an exemplary embodiment, the holding the battery cell may comprises adjusting, by a pusher, a position of the battery cell in a first direction with respect to the rotary holder, determining, by a position sensor, the position of the battery cell held by the rotary holder in a second direction, and adjusting, based on the position of the battery cell, a position of the rotary holder in the second direction.

According to an exemplary embodiment, the rotating the rotary holder may comprise rotating the rotary holder by a preset angle.

According to an exemplary embodiment, the stacking the battery cell may comprise moving the rotary holder toward a support portion of the stacking station.

According to an exemplary embodiment, the method may comprise returning the moved rotary holder to an original position of the rotary holder and moving the conveyor by a preset distance to supply a second battery cell.

According to an exemplary embodiment, the stacking the battery cell may comprises moving a support portion of the stacking station by a preset distance, and linearly moving the rotary holder toward the support portion of the stacking station.

According to an exemplary embodiment, linearly moving the support portion may comprise moving the support portion along the stacking station in an opposite direction of the rotary holder.

According to an exemplary embodiment, the stacking the battery cell may comprise moving the stacking station and a support portion of the stacking station by a preset distance, and moving the battery cell to the stacking station by the rotary holder.

According to an aspect of the present disclosure, a battery may be provided that is manufactured by the method.

The above and other features of the disclosure are discussed infra.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a perspective view of a stacking device, according to an exemplary embodiment of the present disclosure.

FIG. 2 illustrates a perspective view of the stacking device, according to an exemplary embodiment of the present disclosure.

FIG. 3 illustrates a view showing a rotary holder of the stacking device, according to an exemplary embodiment of the present disclosure.

FIG. 4 illustrates a view showing a stacking station of the stacking device, according to an exemplary embodiment of the present disclosure.

FIGS. 5A and 5B illustrate views each showing an alignment position determination process of the stacking device, according to an exemplary embodiment of the present disclosure.

FIGS. 6A, 7A, 8A, 9A, 10A, 11A, 12A, 13A, and 14A illustrate views each showing an operation flow of the stacking device, according to an exemplary embodiment of the present disclosure, and are side views of the stacking device.

FIGS. 6B, 7B, 8B, 9B, 10B, 11B, 12B, 13B, and 14B illustrate views each showing an operation flow of the stacking device, according to an exemplary embodiment of the present disclosure, and are plan views of the stacking device.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions presented in embodiments of the present disclosure are only exemplified for the purpose of describing the embodiments according to the concept of the present disclosure. The embodiments according to the concept of the present disclosure may be performed in various forms. Further, the embodiments should not be interpreted as being limited to the embodiments described in the present specification and should be understood as including all modifications, equivalents, and substitutes included in the spirit and scope of the present disclosure.

Meanwhile, in the present disclosure, terms such as first and/or second may be used to describe various components, but the components are not limited to the terms. The terms are used only for the purpose of distinguishing one component from other components. For example, within the scope not departing from the scope of the rights according to the concept of the present disclosure, a first component may be referred to as a second component, and similarly, the second component may be referred to as the first component.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween. Other expressions for describing a relationship between components, that is, expressions such as “between” and “directly between” or “adjacent to” and “directly adjacent to”, should be also interpreted in the same manner.

Throughout the specification, the same reference numerals refer to the same or equivalent components. The terms used in the present specification are for the purpose of describing the embodiments and are not intended to limit the present disclosure. In the present specification, the singular form is intended to include the plural forms as well, unless the context clearly indicates otherwise. “Comprise” and/or “comprising,” used in the specification, specify the presence of the mentioned component, step, operation, and/or element and does not exclude the presence or addition of one or more other components, steps, operations, and/or elements.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, the present disclosure will be described in detail with reference to the accompanying drawings.

A stacking device 1 configured to stack a plurality of items on each other may be provided. According to an exemplary embodiment, the plurality of items may comprise items having the same shape. According to an exemplary embodiment, the plurality of items may comprise items having different shapes. According to an exemplary embodiment, each item, of the plurality of items, may comprise a battery cell C. Hereinafter, a target to be stacked by the stacking device 1 is described as the battery cell C. The reason for this is that the stacking device 1 of the present disclosure may be configured to effectively solve a unique design problem faced in stacking the battery cells C, as described later. However, it should be understood that the target to be stacked by the stacking device 1 is not limited to the battery cell C.

The battery cell C may comprise an electrode assembly and an exterior material. The electrode assembly may comprise a plurality of cathodes, a plurality of anodes, and a separator. The electrode assembly may be manufactured by stacking the cathodes and the anodes together with the separator. The electrode assembly may be configured to be disposed in an exterior material, such as a pouch. For instance, an electrolyte may be put into the pouch, and then the pouch may be sealed.

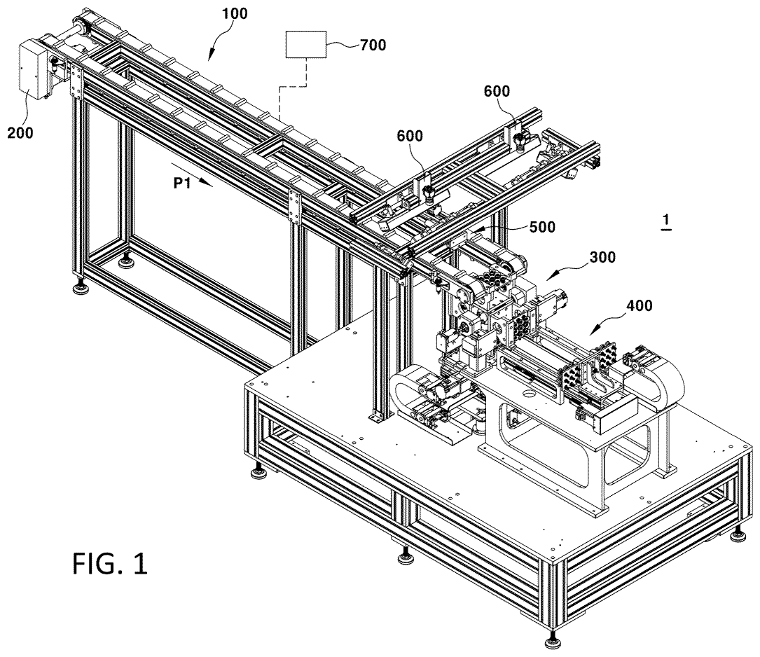

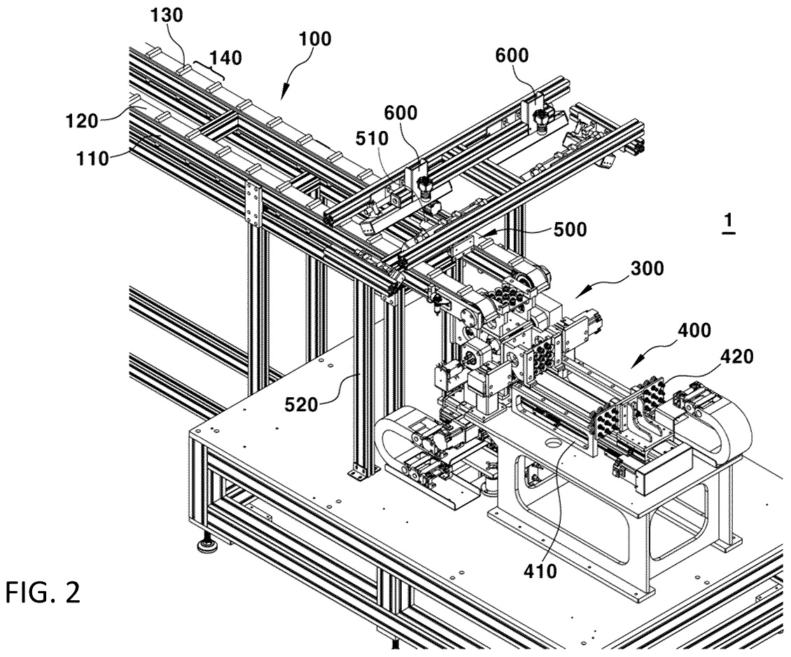

As shown in FIGS. 1 and 2, the stacking device 1 may comprise a conveyor 100. The conveyor 100 may be configured to transport components to be assembled, such as the battery cells C. Since the battery cells C are continuously supplied through the conveyor 100, productivity may be improved. As a non-limiting example, the conveyor 100 may comprise a pitch conveyor. The pitch conveyor may be configured to be moved by a preset pitch and stopped. After a preset time elapses after the pitch conveyor is stopped, the pitch conveyor may be configured to be repeatedly moved by the preset pitch and stopped.

The conveyor 100 may comprise a base 110 and a belt 120. The belt 120 may be configured to move along the base 110. The belt 120 may comprise one or more dividers 130. The dividers 130 may be configured to be disposed on the belt 120 at a preset interval from each other. A distance between the dividers 130 may be referred to as a pitch. The dividers 130 may be configured to be moved by the pitch and may be stopped. Then the dividers 130 may be configured to be moved again after the lapse of a preset time and may be stopped, repeatedly. An arrangement area 140 may be provided between the dividers 130. Each battery cell C may be disposed in the arrangement area 140.

According to an exemplary embodiment, the conveyor 100 may comprise a first conveyor and a second conveyor. Each of the first conveyor and the second conveyor may comprise the base 110 and the belt 120, respectively, and the first conveyor and the second conveyor may be configured to be spaced apart from each other by a predetermined distance. The first conveyor and the second conveyor may be configured to be simultaneously operated.

The stacking device 1 may comprise a conveyor actuator 200. As a non-limiting example, the conveyor actuator 200 may comprise a servomotor. The conveyor 100 may be configured to be repeatedly moved by a preset pitch and stopped by the conveyor actuator 200.

The stacking device 1 may comprise an alignment position. For example, the alignment position may be configured to be disposed at an end portion of the conveyor 100. At the alignment position, the battery cells C supplied to the conveyor 100 may be configured to be aligned to a preset position. According to an exemplary embodiment, a widthwise position of the battery cell C may be aligned with a preset position. According to an exemplary embodiment, a lengthwise position of the battery cell C may be aligned with a preset position. According to an exemplary embodiment, before stacking of the battery cells C, each of the battery cells C may be placed at a correct position or may be placed at a predetermined position.

The stacking device 1 may comprise a rotary holder 300 and a stacking station 400. The stacking station 400 may be configured to be operatively associated with the rotary holder 300 for stacking of the battery cells C. According to an exemplary embodiment, the rotary holder 300 may be configured to align the longitudinal position of the battery cell C. According to an exemplary embodiment, the rotary holder 300 may be configured to stack the battery cells C on the stacking station 400.

The rotary holder 300 may be disposed at the alignment position of the stacking device 1. In one example, the rotary holder 300 may be disposed at the end portion of the conveyor 100 by a frame 310. For example, the rotary holder 300 may be positioned between the first conveyor and the second conveyor. In some embodiments, the rotary holder 300 may be configured to be rotatable. In some embodiments, the rotary holder 300 may be configured to be linearly movable. In one example, the rotary holder 300 may be configured to move upward or downward. In one example, the rotary holder 300 may be configured to move forward or rearward. In one example, the rotary holder 300 may be configured to move leftward and rightward.

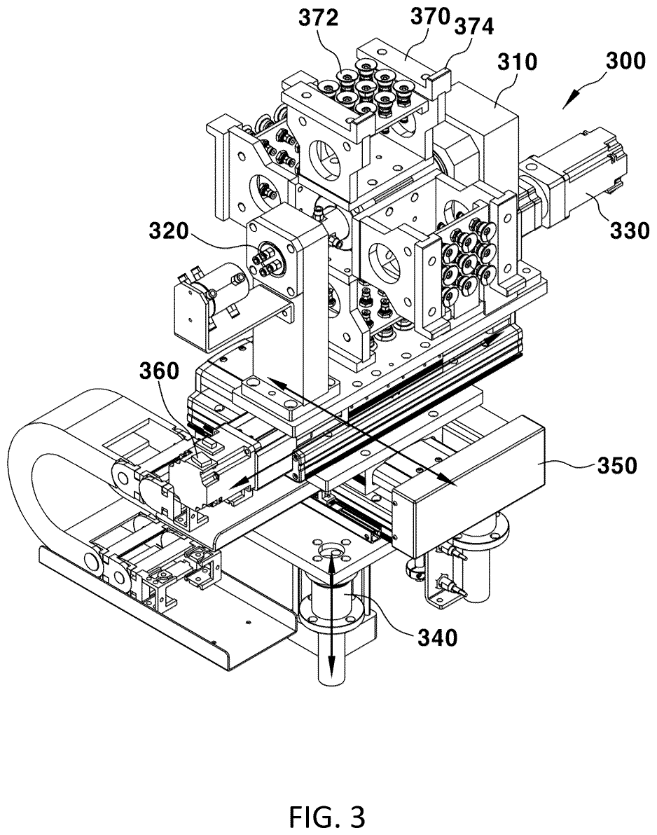

Referring to FIG. 3, the rotary holder 300 may be configured to rotate. The rotary holder 300 may be configured to rotate about a shaft 320. The rotary holder 300 may comprise a rotary actuator 330. The rotary actuator 330 may be configured to provide power to rotate the rotary holder 300. For example, the rotary actuator 330 may comprise a servomotor.

According to an exemplary embodiment, the rotary holder 300 may be configured to move upward or downward. The rotary holder 300 may be configured to move upward from an original position of the rotary holder and may be configured to move downward from the upwardly moved position. The rotary holder 300 may include a first actuator 340. The first actuator 340 may be configured to provide power to perform upward movement or downward movement of the rotary holder 300. As a non-limiting example, the first actuator 340 may comprise a servomotor.

According to an exemplary embodiment, the rotary holder 300 may be configured to move forward or rearward. The rotary holder 300 may be configured to move forward from the original position of the rotary holder 300 toward the stacking station 400 or may be configured to move rearward from the stacking station 400. The battery cells C may be stacked on the stacking station 400 by rotation operation and forward movement of the rotary holder 300.

The rotary holder 300 may comprise a second actuator 350. The second actuator 350 may be configured to provide power to perform forward movement or rearward movement of the rotary holder 300. For example, the second actuator 350 may comprise a servomotor.

According to an exemplary embodiment, the rotary holder 300 may be configured to move leftward and rightward. The longitudinal position of the battery cell C disposed in the rotary holder 300 may be adjusted by leftward-and-rightward movement of the rotary holder 300.

The rotary holder 300 may comprise a third actuator 360. The third actuator 360 may be configured to provide power to perform leftward movement or rightward movement of the rotary holder 300. In one example, the third actuator 360 may comprise a servomotor.

The rotary holder 300 may comprise a holder portion 370. The holder portion 370 may be configured to hold the battery cell C. As a non-limiting example, the holder portion 370 may be configured to hold the battery cell C through vacuum suction. According to an exemplary embodiment, the holder portion 370 may comprise a plurality of vacuum pads 372 each configured to receive a vacuum.

The rotary holder 300 may comprise a plurality of holder portions 370. The respective holder portions 370 may be disposed along the circumference of the rotary holder 300. For example, the respective holder portions 370 may be disposed at an interval of 90 degrees around the circumference of the holder portion 370. In the illustrated embodiment, four holder portions 370 are disposed on the rotary holder 300, but the number of holder portions 370 may be increased or decreased.

The holder portion 370 may comprise a stopper 374. The stopper 374 may be configured to prevent separation of the battery cell C supplied from the conveyor 100 to the holder portion 370. The stopper 374 may be operatively associated with a pusher 500.

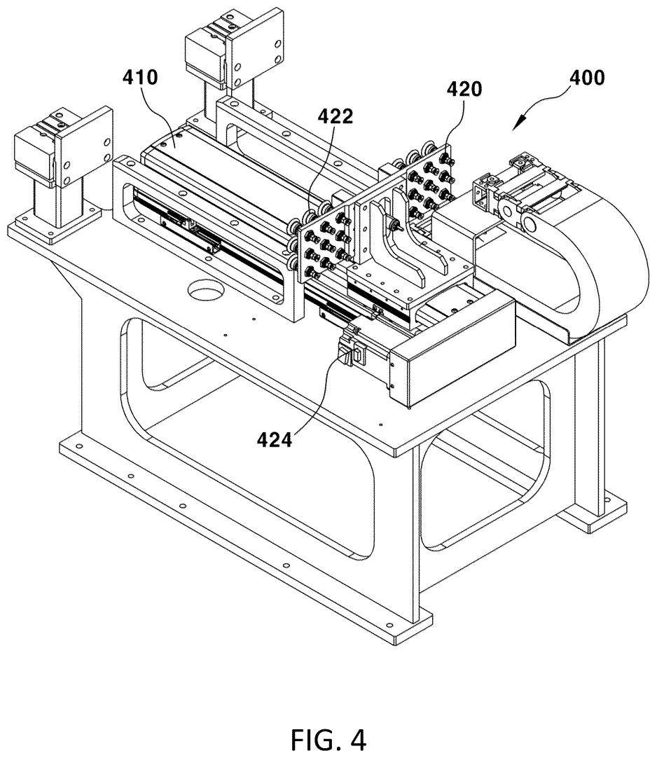

Referring to FIG. 4, the stacking station 400 may be configured to stack the supplied battery cells C. The stacking station 400 may comprise a base portion 410 and a support portion 420.

The battery cells C supplied from the rotary holder 300 may be disposed or stacked on the base portion 410. In some embodiments, the base portion 410 is configured to be rotatable. For example, the base portion 410 may comprise a pitch conveyor.

The support portion 420 may be disposed at the base portion 410. In some embodiments, the support portion 420 may be configured to move along the base portion 410. In some embodiments, the support portion 420 may be configured to move together with the base portion 410.

The support portion 420 may be configured to hold the battery cells C to be stacked on the stacking station 400. For example, the support portion 420 may be configured to grip the widthwise surface of the battery cell C. The support portion 420 may be configured to grip the widthwise surface of the battery cell C to be initially stacked on the stacking station 400. According to an exemplary embodiment, the support portion 420 may be configured grip the battery cell C through vacuum suction. The support portion 420 may comprise a plurality of vacuum pads 422 each configured to form a vacuum therein.

In one example, the support portion 420 may be configured to move along the stacking station 400. As the number of battery cells C stacked on the stacking station 400 increases, the support portion 420 may be configured to move rearward or may be configured to move in a direction away from the rotary holder 300 so as to newly stack the battery cell C on the stacking station 400. The support portion 420 may comprise an actuator 424. The actuator 424 may be configured to provide moving force to the support portion 420. As a non-limiting example, the actuator 424 may comprise a servomotor.

In another example, the support portion 420 may be configured to move together with the stacking station 400. The support portion 420 may be fixed to the stacking station 400, and the stacking station 400 may be configured to rotate, thereby forming a space for the battery cell C to be newly stacked. In one example, the stacking station 400 may comprise a rotary actuator 430. The rotary actuator 430 may be configured to provide rotational force to the stacking station 400. As a non-limiting example, the stacking station 400 may comprise a pitch conveyor.

The stacking station 400 may be configured to move by a preset pitch and stop during its operation. When the battery cells C are pushed or pulled in a state of being disposed in the thickness direction thereof, the battery cells C may be damaged due to friction with the bottom surface of the stacking station 400. In the present embodiment, the stacking station 400, that is, the bottom surface on which the battery cells C are placed, may be configured to move, thereby preventing friction between the battery cells C and the bottom surface.

The stacking device 1 may comprise the pusher 500. The pusher 500 may be configured to align the battery cells C in the width direction of the battery cells C. According to an exemplary embodiment, the stacking device 1 may comprise a pusher actuator 510. As a non-limiting example, the pusher actuator may comprise a servomotor.

The pusher 500 may be supported by a support frame 520. In one example, the pusher 500 may be disposed on top of the conveyor 100 and may be supported by the support frame 520.

The pusher 500 may be configured to be operated to move forward or rearward by the pusher actuator 510. The pusher 500 may be configured to push the battery cell C disposed in the holder portion 370 by a forward operation of the pusher 500. The battery cell C disposed at the holder portion 370 may be configured to be pushed to the stopper 374 by the forward operation of the pusher 500. The widthwise positions of the battery cells C may be aligned by the operation of the pusher 500. The arrangement area 140 of the conveyor 100 may be formed to be larger than a specific battery cell C so as to accommodate the battery cells C having various sizes. Since the holder portion 370 places the corresponding battery cells C in the holder portion 370 without alignment of the battery cells, the widthwise positions of the respective battery cells C may not be aligned. According to the disclosed embodiment, a pushing operation may be performed by the pusher 500 such that, despite the size of the arrangement area 140, all the battery cells C are placed at the same widthwise position before being stacked. In this manner, the widthwise positions of the stacked battery cells may be aligned.

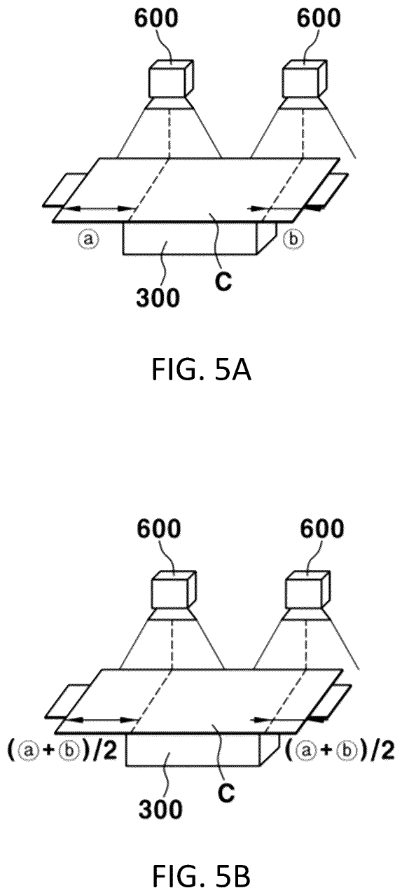

Referring to FIGS. 5A and 5B, the stacking device 1 may comprise a position sensor 600. The position sensor 600 may be configured to provide position information on the battery cell C supported by the holder portion 370. According to an exemplary embodiment, the position sensor 600 may comprise a machine vision camera. In some implementations, the position sensor 600 may comprise two or more position sensors 600. In this case, it is possible to detect whether a virtual line of the battery cell C, detected by the position sensor 600, coincides with a preset reference line. According to the disclosed embodiment, it may be possible to prevent misalignment of the battery cells C due to lead lifting of the battery cells C through alignment based on the position sensor 600 or the machine vision camera.

The stacking device 1 may comprise a controller 700. The controller 700 may be configured to adjust the operation of the stacking device 1. According to an exemplary embodiment, the controller 700 may be configured to control the operation of the conveyor actuator 200. According to an exemplary embodiment, the controller 700 may be configured to control the operation of the rotary actuator 330, the first actuator 340, the second actuator 350, or the third actuator 360 of the rotary holder 300. According to an exemplary embodiment, the controller 700 may be configured to control the supply of vacuum provided to the holder portion 370 or the support portion 420. According to an exemplary embodiment, the controller 700 may be configured to control the operation of the stacking station 400. For example, the controller 700 may be configured to move or stop the stacking station 400 or the support portion 420. According to an exemplary embodiment, the controller 700 may be configured to control the operation of the pusher actuator 510. The controller 700 may be configured to operate the pusher actuator 510 so as to operate the pusher 500 at a preset time.

The controller 700 may be configured to communicate with the position sensor 600. The controller 700 may be configured to collect information detected by the position sensor 600 and may be configured to control the operation of the rotary holder 300 or the third actuator 360 based on the collected information. According to an exemplary embodiment, the controller 700 may be configured to receive, from the position sensor 600, information on a distance between a virtual line of the battery cell C and each end thereof, may be configured to compare the received distance information with preset distance information (information on a distance between a reference line of the battery cell C to the end thereof), and may be configured to control the operation of the third actuator 360 such that the virtual line and the reference line coincide with each other.

According to an exemplary embodiment, the operation of the stacking device 1 may be performed in the following manner.

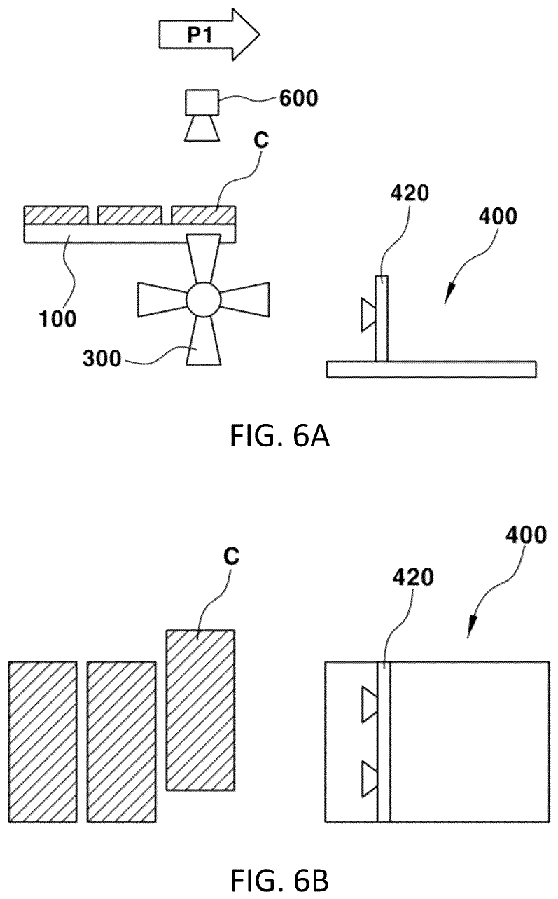

As shown in FIGS. 6A and 6B, the battery cells C may be supplied by the conveyor 100. The battery cells C may be disposed in the respective arrangement areas 140, partitioned by the dividers 130. The conveyor 100 may be configured to supply the battery cells C in a direction P1.

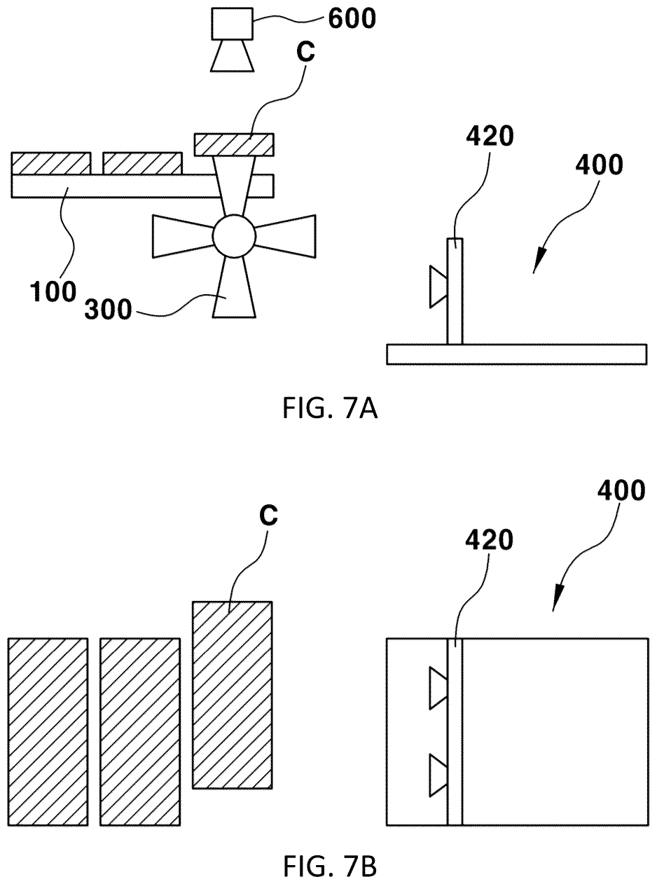

As shown in FIGS. 7A and 7B, the battery cell C reaching the alignment position of the stacking device 1 may be held by the rotary holder 300. The rotary holder 300 may be configured to be moved in the upward direction toward the position sensor 600. The position sensor 600 may be disposed, for example, on the upper portion of the stacking device 1.

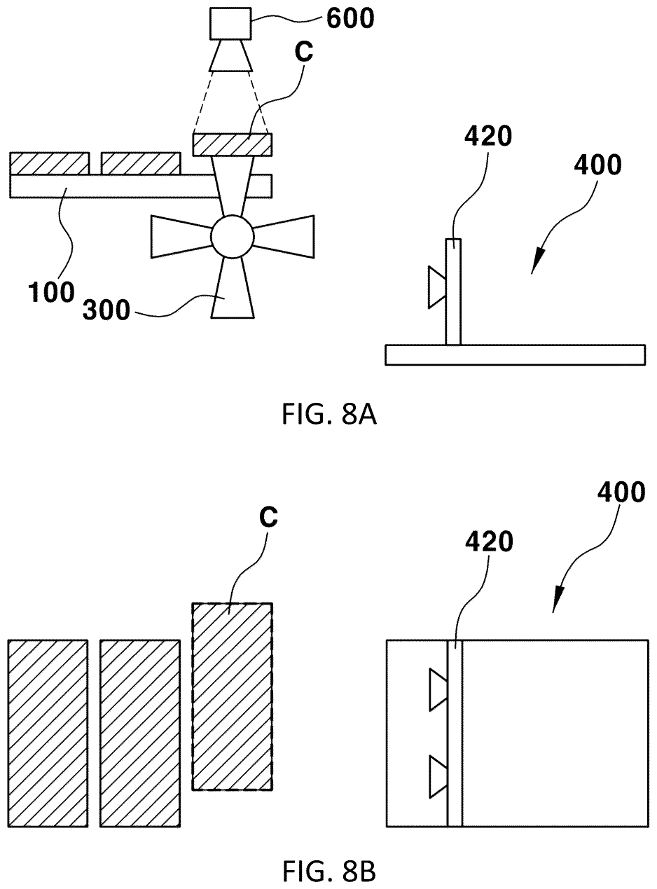

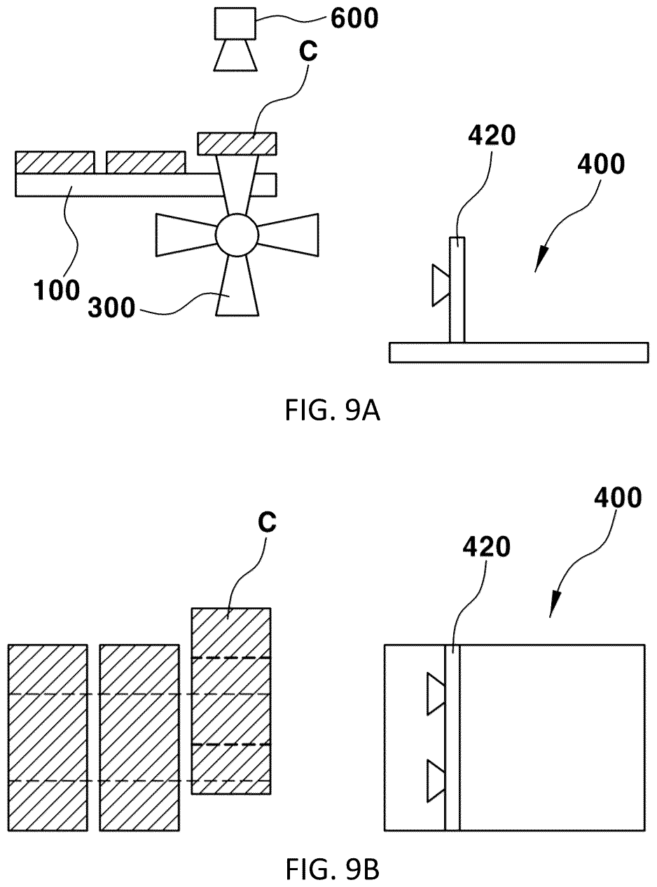

As shown in FIGS. 8A, 8B, 9A, and 9B, the position sensor 600 may be configured to detect a virtual line detected from the battery cell C disposed in the holder portion 370. The controller 700 may be configured to compare the position of the virtual line detected by the position sensor 600 with the position of a preset reference line, and to determine a distance between the two positions.

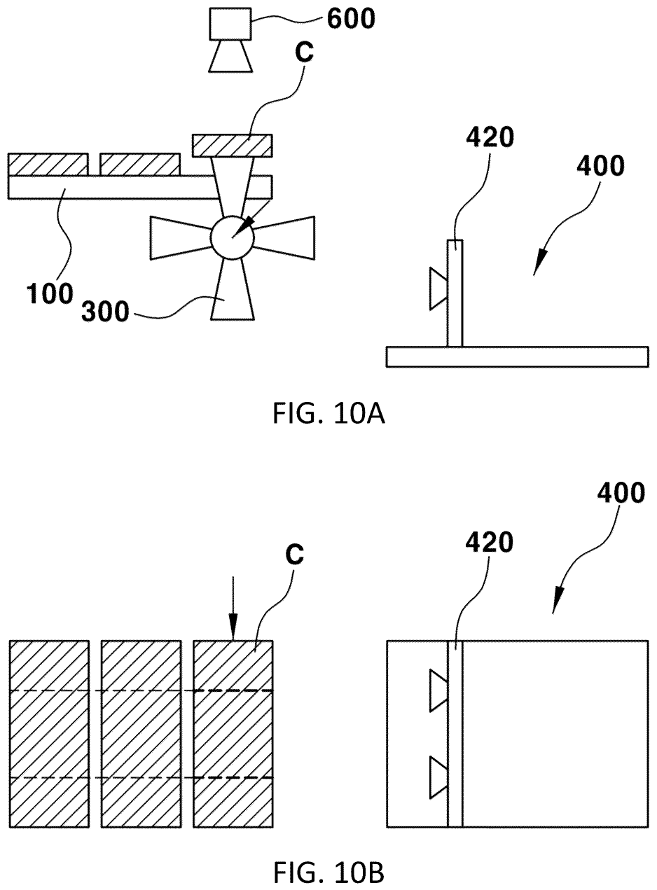

As shown in FIGS. 10A and 10B, the controller 700 may be configured to align the longitudinal positions of the battery cells C by moving the rotary holder 300 to the left or right so that the virtual line and the reference line coincide with each other.

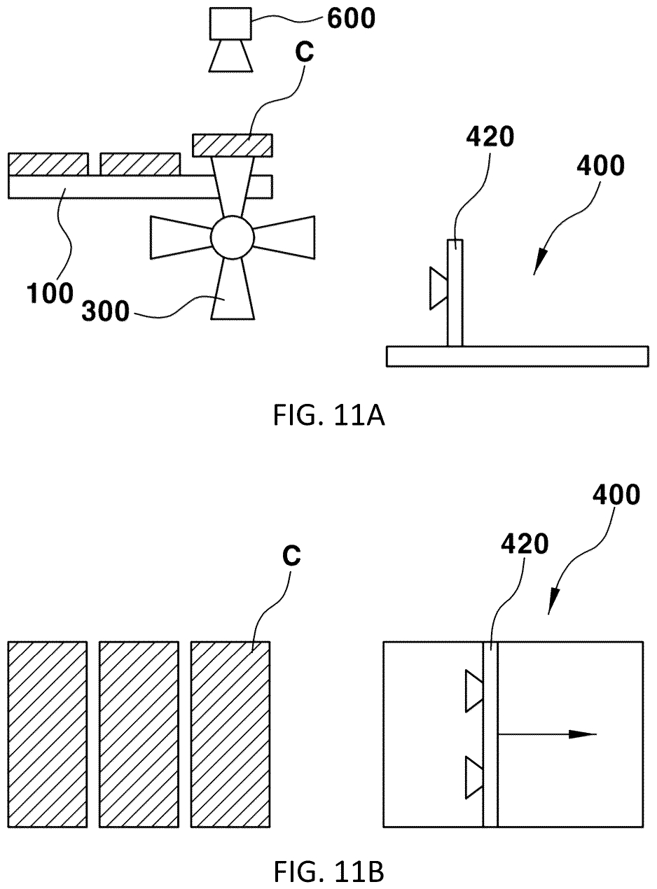

As shown in FIGS. 11A and 11B, the stacking station 400 may be configured to, based on the longitudinal positions of the battery cells C being at the correct positions, provide a space for stacking of the battery cell C held by the holder portion 370. The space may be provided by rotation of the stacking station 400 (movement by a pitch) or movement of the support portion 420.

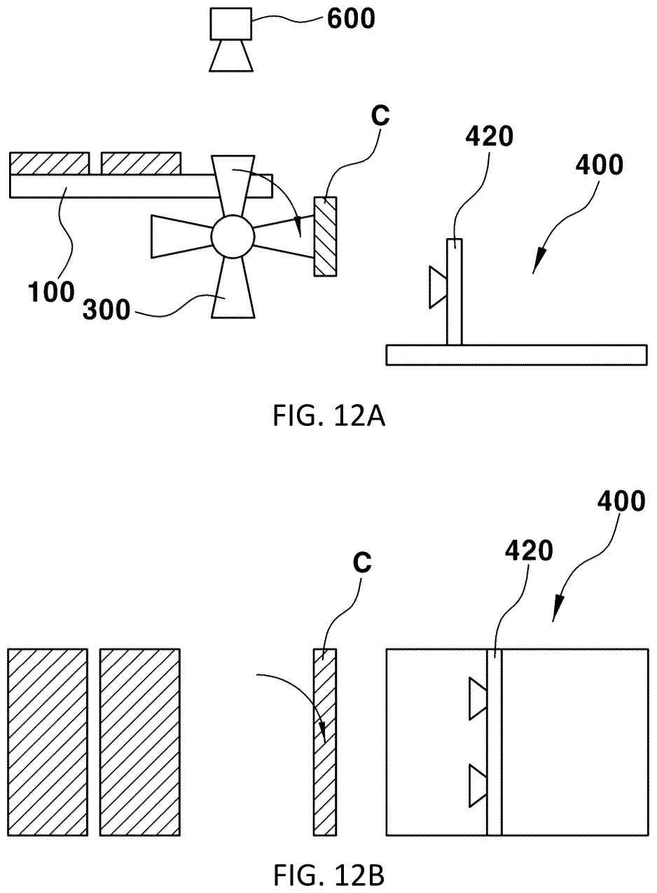

As shown in FIGS. 12A and 12B, the rotary holder 300 may be configured to rotate the battery cell C by a preset angle (90° in the illustrated example).

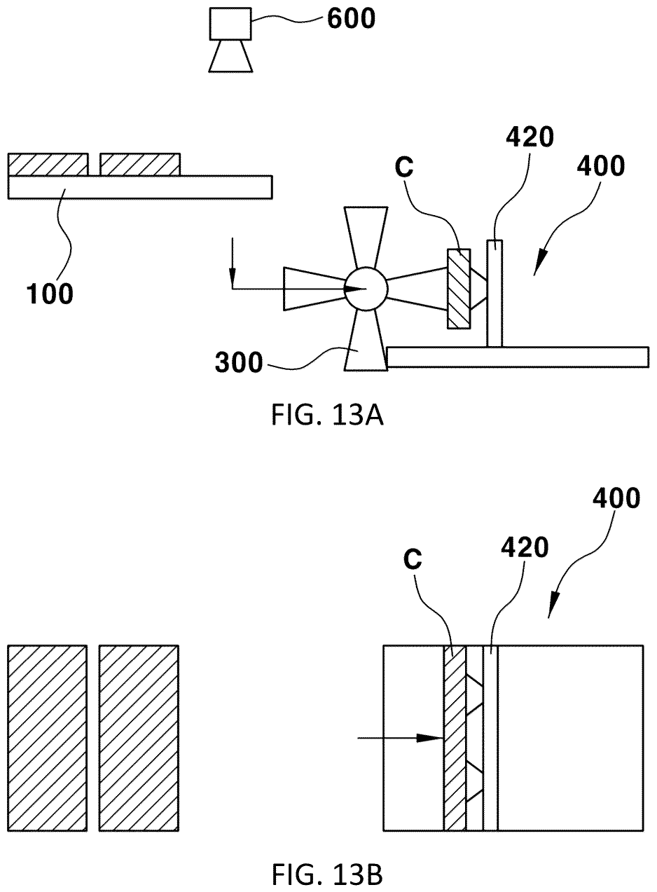

As shown in FIGS. 13A and 13B, the rotary holder 300 that has been moved upward from the alignment position may be configured to be moved downward to its original position and then moved forward toward the support portion 420. The holder portion 370 of the rotary holder 300 ends vacuum suction, and the battery cell C held by the rotary holder 300 may be attached to the support portion 420 through the vacuum pad 422 of the support portion 420. When the battery cell is not a battery cell disposed at the end among the stacked battery cells, the rotary holder 300 may place the battery cell C in the space provided in the stacking device through the above-mentioned downward movement and forward movement thereof.

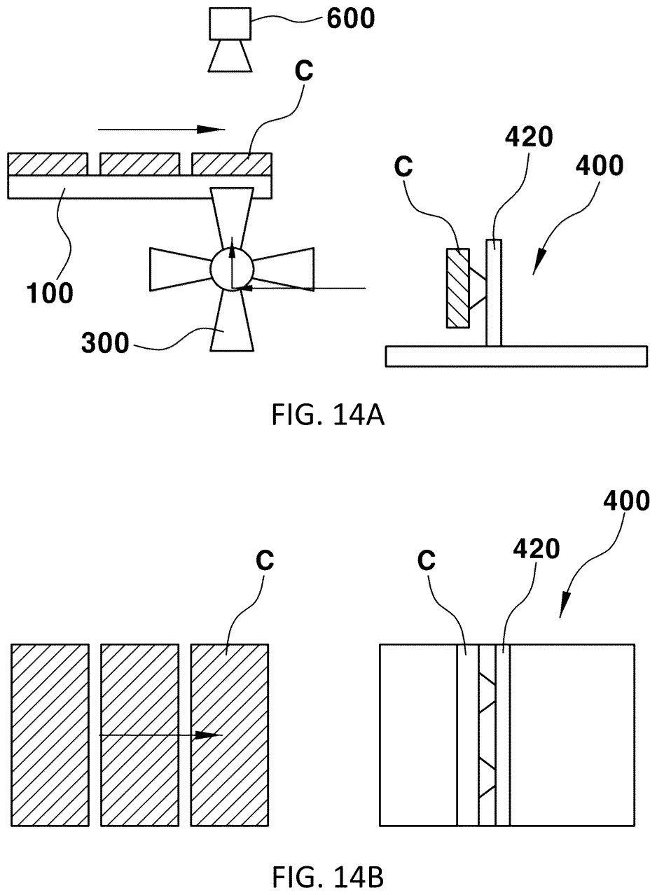

As shown in FIGS. 14A and 14B, when the stacking of the battery cells C is completed at the stacking station 400, the rotary holder 300 may be moved rearward to its original position. Then, when the next battery cell C on the conveyor 100 is moved to the alignment position, stacking of the battery cells C may be continuously performed. According to the disclosed embodiment, since the alignment of the battery cells C, the rotation operation of the rotary holder 300, and the stacking operation of the rotary holder 300 are simultaneously performed, stacking of the battery cells C may be performed at high speed.

In some embodiments, a battery-manufacturing device may comprise the stacking device 1. The battery-manufacturing device may be configured to manufacture the battery cells C stacked by the stacking device 1 into a battery module or a battery pack.

In some embodiments, a battery may be manufactured by the above-described stacking method.

In some embodiments, a vehicle may comprise a battery manufactured by a stacking device.

The present disclosure may provide a stacking device and a stacking method capable of effectively, efficiently, and rapidly stacking a large number of items.

The present disclosure may be configured to provide a stacking device capable of accurately aligning battery cells to be stacked.

The present disclosure may provide a stacking device and a stacking method capable of reducing manufacturing costs through a simplified structure.

According to the present disclosure, since battery cells are stacked in the horizontal direction (in the left-and-right direction), it is possible to stack a large number of battery cells compared to vertical stacking of the battery cells.

As is apparent from the above description, the present disclosure provides a stacking device and a stacking method capable of effectively and efficiently stacking a large number of items.

The effects of the present disclosure are not limited to the above-mentioned effects, and other effects not mentioned herein will be clearly understood by those skilled in the art from the detailed description of the embodiments.

The present disclosure described above is not limited to the above-described embodiments and the accompanying drawings, and it will be apparent to those skilled in the art to which the present disclosure pertains that various substitutions, modifications, and changes are possible within the scope not departing from the technical idea of the present disclosure.

What is claimed is:

1. A stacking device, comprising:
a rotary holder comprising a holder portion,
wherein the rotary holder is configured to rotate; and
a stacking station comprising a support portion,
wherein the stacking station is configured to be operatively associated with the rotary holder.

2. The stacking device of claim 1, further comprising a conveyor,
wherein the rotary holder is configured to move in one or more of a first direction, a second direction, or a third direction relative to the conveyor.

3. The stacking device of claim 1, wherein the rotary holder is configured to:
rotate toward the support portion; and
move toward the support portion.

4. The stacking device of claim 3, wherein the support portion is configured to move along, or together with, the stacking station.

5. The stacking device of claim 1, further comprising:
a position sensor; and
a controller configured to adjust, based on information from the position sensor, a position of the rotary holder.

6. The stacking device of claim 1, further comprising a pusher configured to move toward the rotary holder.

7. The stacking device of claim 1, wherein:
the rotary holder comprises a plurality of holder portions disposed along a circumference of the rotary holder, and
each of the holder portions comprises a vacuum pad configured to receive a vacuum.

8. A battery-manufacturing device, comprising:
a stacking device, comprising:
a conveyor;
a rotary holder comprising a holder portion,
wherein the rotatory holder is configured to:
rotate; and
move relative to the conveyor; and
a stacking station comprising a support portion,
wherein the stacking station is configured to be operatively associated with the rotary holder.

9. A method of stacking battery cells, the method comprising:
supplying a battery cell by a conveyor;
holding the battery cell by a rotary holder;
rotating the rotary holder; and
stacking, on a stacking station, the battery cell rotated by the rotary holder.

10. The method of claim 9, further comprising:
determining, by a position sensor, a position of the battery cell held by the rotary holder; and
adjusting a position of the rotary holder based on the position of the battery cell.

11. The method of claim 10, wherein the determining a position of the battery cell comprises moving the rotary holder toward the position sensor.

12. The method of claim 9, further comprising moving, by a pusher, the battery cell held by the rotary holder to a preset position.

13. The method of claim 9, wherein the holding the battery cell comprises:
adjusting, by a pusher, a position of the battery cell in a first direction with respect to the rotary holder;
determining, by a position sensor, the position of the battery cell held by the rotary holder in a second direction; and
adjusting, based on the position of the battery cell, a position of the rotary holder in the second direction.

14. The method of claim 9, wherein the rotating the rotary holder comprises rotating the rotary holder by a preset angle.

15. The method of claim 9, wherein the stacking the battery cell comprises moving the rotary holder toward a support portion of the stacking station.

16. The method of claim 15, further comprising:
returning the moved rotary holder to an original position of the rotary holder; and
moving the conveyor by a preset distance to supply a second battery cell.

17. The method of claim 9, wherein the stacking the battery cell comprises:
moving a support portion of the stacking station by a preset distance; and
linearly moving the rotary holder toward the support portion of the stacking station.

18. The method of claim 17, wherein linearly moving the support portion comprises moving the support portion along the stacking station in an opposite direction of the rotary holder.

19. The method of claim 9, wherein the stacking the battery cell comprises:
moving the stacking station and a support portion of the stacking station by a preset distance; and
moving the battery cell to the stacking station by the rotary holder.

20. A battery manufactured by the method of claim 9.
